(19) United States
(12) Patent Application Publication
(10) Pub. No.: US 2009/0274859 A1
(43) Pub. Date: Nov. 5, 2009

(54) PROCESS FOR PRODUCING A DOUBLE-SIDED PRESSURE-SENSITIVE ADHESIVE TAPE AND ITS USE

(75) Inventors: Marc Husemann, Hamburg (DE); Bernd Dietz, Ammersbek (DE)

Correspondence Address: NORRIS, MCLAUGHLIN & MARCUS, PA, 875 THIRD AVENUE, 18TH FLOOR, NEW YORK, NY, 10022, US

(73) Assignee: tesa AG, Hamburg (DE)

(21) Appl. No.: 12/440,030

(22) PCT Filed: Sep. 5, 2007
(86) PCT No.: PCT/EP07/59266

§ 371 Date: Mar. 25, 2009

(30) Foreign Application Priority Data
Sep. 11, 2006 (DE) 10 2006 043 259.2

(51) Int. Cl. C09J 7/02; B32B 7/10; B32B 7/06; B29C 47/06

(52) U.S. Cl. 428/41.8; 264/173.12; 264/173.11; 156/244.22

(57) ABSTRACT

For the production of a double-sided pressure-sensitive adhesive tape, having a closed and open side, possessing a carrier film (e) provided on both sides with a pressure-sensitive adhesive layer (c,c′), the carrier film (e) being a filmlike carrier film not based on rubber, and there bring at least one release film located on the closed side, on the one pressure-sensitive adhesive layer (c), it is envisaged that, from the melt, two identical or different pressure-sensitive adhesives for the pressure-sensitive adhesive layers (c,c′), a film-forming polymer for the carrier film (e), and a film-forming polymer for the release film be formed, that these components be combined to form a composite, and that the pressure-sensitive adhesives be crosslinked by means of physical and/or radiation-chemical treatment.

The invention relates to the producing of a double-sided pressure-sensitive adhesive tape with a closed and an open side, which comprises a carrier film provided on both sides with a pressure-sensitive adhesive layer, the carrier film being a carrier film not based on rubber. Located on the closed side, on one of the pressure-sensitive adhesive layers, is at least one release film. In accordance with the invention the producing takes place preferably by means of a coextrusion process. Also subject matter of the invention is the double-sided pressure-sensitive adhesive tape per se, and its use particularly in the electronics sector.

Industrial pressure-sensitive adhesive tape applications very often use polyacrylate pressure-sensitive adhesives. Polyacrylates possess a variety of advantages over other elastomers. They are highly stable toward UV light, oxygen, and ozone. Synthetic and natural-rubber adhesives usually contain double bonds, making these adhesives unstable to the aforementioned environmental effects. Another advantage of polyacrylates is their capacity for use across a relatively wide temperature range. These polyacrylate pressure-sensitive adhesives are generally prepared in solution by a free radical polymerization. The polyacrylates are coated in solution or from the melt, via a coating bar, onto the corresponding carrier material, and then dried. To increase the cohesion the polymer is crosslinked. Curing proceeds thermally or by UV crosslinking or by EB curing (EB: electron beam). The operation described is relatively costly, and so the double-sided pressure-sensitive adhesive tapes based on acrylate pressure-sensitive adhesives are relatively more expensive.

There have therefore been a large number of efforts to produce a double-sided adhesive tape under more favorable terms. To raise the efficiency, the hotmelt technology is being introduced more and more, as for example through the processing of the UVac resins from BASF AG. Omitting the solvent circumvents the problem of formation of bubbles during the drying of the solvent borne polyacrylate pressure-sensitive adhesives. And yet it is still necessary to employ two coating steps, which in turn slows down the operation and makes it more expensive. Furthermore, in order to produce a double-sided pressure-sensitive adhesive tape, it is also still necessary to laminate on the carrier material, and so this step may likewise be rate-determining for the operation as a whole.

The aim is therefore to produce a double-sided pressure-sensitive adhesive tape in one operating step. The operation ought preferably to encompass the adhesives (front and back), the carrier material, and release liner (release film). The object on which the invention was based was that of producing a pressure-sensitive adhesive tape which can be used in particular in the electronics sector and which ought to be easily and inexpensively producible and also highly diecuttable.

The invention is realized according to the claims, in which film carrier materials not based on rubber are used as carrier films. The invention provides a process for producing a double-sided pressure-sensitive adhesive tape with a closed and an open side, which comprises a carrier film e which is not based on rubber and which is provided on both sides with a pressure-sensitive adhesive layer c, c′. Located on the side referred to as closed (on one pressure-sensitive adhesive layer c) there is at least one release film.

The process of the invention is characterized in that
two identical or different pressure-sensitive adhesives, to form the pressure-sensitive adhesive layers c, c′,
a film-forming polymer, to form the carrier film e, and
a film-forming polymer, to form the release film,
   are formed from the melt and combined to form an assembly, and the pressure-sensitive adhesives are crosslinked by physical treatment and/or chemical radiation treatment.

Preferably, furthermore, between the carrier film e and the pressure-sensitive adhesive layers c, c′ at least one primer layer d is formed. The at least one release film comprises a carrier film b (release liner) which if desired has a release layer (parting layer) a, a′ on one or both sides.

Surprisingly it has been found that double-sided pressure-sensitive adhesive tapes can be produced outstandingly in one operating step in particular by means of coextrusion technology.

The invention therefore relates in particular to a process for producing double-sided pressure-sensitive adhesive tapes that comprises, by means of the process of coextrusion, the following steps, where
a) 2 identical or different hotmelt pressure-sensitive adhesives are extruded,
b) the carrier film is extruded,
c) the release film, consisting of carrier film (release liner) and, if desired, release layer(s), is extruded,
   and these constituents are then combined to form a double-sided assembly, and crosslinked by physical or chemical radiation treatment of the hotmelt pressure-sensitive adhesive or adhesives, and then rolled up to give the completed double-sided adhesive tape.

In a further preferred version of the invention, in parallel to the abovementioned extrusion layers a), b), and c), one or more anchoring layers (primer layers d) are also coextruded between the carrier film e and the two layers of hotmelt pressure-sensitive adhesive.

### Hotmelt PSAs

As hotmelt pressure-sensitive adhesives (hotmelt PSAs) c, c′ it is possible to use virtually all PSAs which can be processed from the melt. One preferred version uses PSAs based on styrene block copolymers. Examples of suitable base polymers are styrene-isoprene-styrene block copolymers (SIS), styrene-butadiene-styrene block copolymers (SBS) or styrene-ethylene/butylene-styrene block copolymers (SEBS). Besides these block copolymers it is also possible to use functionalized block copolymers of the aforementioned types as base polymers, and in that case these block copolymers may carry maleic anhydride or epoxy functions. In another version, as a second component, diblock copolymers of styrene-isoprene, styrene-butadiene or styrene-ethylene/butylene type are added. These components are admixed in order to modify the adhesive properties. As a result of the different glass transition temperatures there is microphase separation, and hard and soft domains are formed, the hard domains, in a spherical phase structure, constituting physical linkage points which provide the hotmelt PSA with cohesion after cooling to room temperature. These hotmelt PSAs therefore do not necessarily require additional crosslinking, as with UV light or with electron beams, for example.

Another version of the invention uses hotmelt PSAs based on block copolymers of the general type P(A)-P(B)-P(A) and P(B)-P(A)-P(B).

The invention accordingly preferably relates to hotmelt PSAs based on at least one block copolymer, where a block copolymer comprises at least the unit P(A)-P(B)-P(A) composed of at least one polymer block P(B) and at least two polymer blocks P(A), and where
P(A) independently of one another are homopolymer or copolymer blocks of monomers A, the polymer blocks P(A) each having a softening temperature in the range from +20° C. to +175° C.,
P(B) represents a homopolymer or copolymer block of monomers B, the polymer block P(B) having a softening temperature in the range from −130° C. to +10° C., and
the polymer blocks P(A) and P(B) are not homogeneously miscible with one another.

The invention further relates to hotmelt PSAs based on at least one block copolymer at least containing the unit P(B)-P(A)-P(B) composed of at least two polymer blocks P(B) and at least one polymer block P(A), and where
P(A) independently of one another are homopolymer or copolymer blocks of monomers A, the polymer blocks P(A) each having a softening temperature in the range from +20° C. to +175° C.,
P(B) represents a homopolymer or copolymer block of monomers B, the polymer block P(B) having a softening temperature in the range from −130° C. to +10° C., and
the polymer blocks P(A) and P(B) are not homogeneously miscible with one another.

The polymer blocks P(A) are also referred to below as “hard blocks”, and the polymer blocks P(B) as “elastomer blocks”. Furthermore, in the text below, the block copolymers which contain the unit P(A)-P(B)-P(A) are referred to as triblock copolymers. Block copolymers containing the unit P(B)-P(A)-P(B) are referred to as inverse triblock copolymers.

By softening temperature in this context is meant the glass transition temperature in the case of amorphous systems and the melting temperature in the case of semicrystalline polymers. Glass transition temperatures are reported as results from quasistatic processes such as, for example, Differential Scanning Calorimetry (DSC).

In further embodiments the triblock copolymers P(A)-P(B)-P(A) and P(B)-P(A)-P(B) used may also have other structural features. These can be described by the following general formulae:

P(B)-P(A)-P(B)-P(A)-P(B) (I)

[P(B)-P(A)]ₙX (II)

[P(A)-P(B)]ₙX (III)

[P(B)-P(A)]ₙX[P(A)]ₘ (IV)
where n=3 to 12, m=3 to 12, and X represents a polyfunctional branching unit, e.g., a chemical component via which different polymer arms are linked to one another,
the polymer blocks P(A) independently of one another representing homopolymer or copolymer blocks of the monomers A, the polymer blocks P(A) each having a softening temperature in the range from +20° C. to +175° C.,
and where the polymer blocks P(B) independently of one another represent homopolymer or copolymer blocks of the monomers B, the polymer blocks P(B) each having a softening temperature in the range from −130° C. to +10° C.

The chain length of the polymer blocks P(A) and P(B) of the inverse triblock P(B)-P(A)-P(B) is preferably chosen such that it does not exceed that of the polymer block which is preferably miscible or associable with it, and advantageously is 10% less, very advantageously 20% less, than the latter length. The B block can also be chosen such that its length does not exceed half the block length of the B block of the triblock copolymer, or else is shorter.

Monomers used advantageously for the elastomer blocks P(B) are acrylic monomers. Suitable in principle for this purpose are all of the acrylic compounds familiar to the skilled worker that are suitable for the synthesis of polymers. It is preferred to choose those monomers which produce glass transition temperatures of the polymer blocks P(B), including in combination with one or more further monomers, of less than +10° C. Accordingly it is possible with preference to choose the vinyl monomers.

The polymer blocks P(B) are advantageously prepared using 75% to 100% by weight of acrylic and/or methacrylic acid derivatives of the general structure

CH₂—CH(R¹)(COOR²) (V)

where R¹═H or CH₃ and R²═H or linear, branched or cyclic, saturated or unsaturated alkyl radicals having 1 to 30, more particularly having 4 to 18, carbon atoms, and/or up to 25% by weight of vinyl compounds (V) which favorably contain functional groups.

Acrylic monomers used very preferably in the sense of compound (V) as components for polymer blocks P(B) include acrylic and methacrylic esters with alkyl groups consisting of 4 to 18 C atoms. Specific examples of such compounds, without wishing to be restricted by this enumeration, are n-butyl acrylate, n-pentyl acrylate, n-hexyl acrylate, n-heptyl acrylate, n-octyl acrylate, n-nonyl acrylate, lauryl acrylate, stearyl acrylate, stearyl methacrylate, their branched isomers, such as 2-ethylhexyl acrylate and isooctyl acrylate, for example, and also cyclic monomers such as cyclohexyl or norbornyl acrylate and isobornyl acrylate, for example.

As monomers in the sense of the definition (V) for polymer blocks P(B) it is additionally and optionally possible to use vinyl monomers from the following groups: vinyl esters, vinyl ethers, vinyl halides, vinylidene halides, and also vinyl compounds which contain aromatic rings and heterocycles in α position. Here again, exemplary mention may be made of selected monomers that can be employed in accordance with the invention: vinyl acetate, vinyl formamide, vinyl pyridine, ethyl vinyl ether, 2-ethylhexyl vinyl ether, butyl vinyl ether, vinyl chloride, vinylidene chloride, and acrylonitrile.

Suitable and particularly preferred examples of vinyl-group-containing monomers in the sense of the definition (V) for the elastomer blocks P(B) further include hydroxyethyl acrylate, hydroxypropyl acrylate, hydroxyethyl methacrylate, hydroxypropyl methacrylate, n-methylolacrylamide, acrylic acid, methacrylic acid, allyl alcohol, maleic anhydride, itaconic anhydride, itaconic acid, benzoin acrylate, acrylated benzophenone, acrylamide, and glycidyl methacrylate, to name but a few.

Starting monomers for the polymer blocks P(A) are preferably selected such that the resulting polymer blocks P(A) are immiscible with the polymer blocks P(B) and, accordingly, microphase separation occurs. Advantageous examples of compounds which are used as monomers A are vinylaromatics, which may also have been alkylated, methyl methacrylate, cyclohexyl methacrylate, isobornyl methacrylate, and isobornyl acrylate.

Particularly preferred examples are methyl methacrylate and styrene; this enumeration makes no claim to completeness.

Furthermore, however, the polymer blocks P(A) may also be constructed as a copolymer which can be composed of at least 75% of the above monomers A, leading to a high softening temperature, or of a mixture of these monomers, but includes up to 25% of monomers B which lead to a reduction in the softening temperature of the polymer block P(A). In this sense mention may be made, by way of example but not exclusively, of alkyl acrylates, which are defined in accordance with the structure (V) and the comments made in relation thereto.

As polyacrylate hotmelt PSA in a further version of the invention are polymers based on
at least 50% by weight of an acrylic ester and/or methacrylic ester having the formula CH₂═CH(R₁)(COOR₂), where R₁═H or CH₃ and R₂ is a linear, branched or cyclic alkyl chain having 1-20 C atoms.

The monomers are preferably chosen such that the resulting polymers can be employed as PSAs at room temperature or higher temperatures, more particularly such that the resulting polymers possess pressure-sensitive adhesive properties in accordance with the “Handbook of Pressure Sensitive Adhesive Technology” by Donatas Satas (van Nostrand, New York 1989).

In a very preferred way use is made of acrylic or methacrylic monomers for the 3 layers A, B, and C, consisting of acrylic and methacrylic esters having alkyl groups of 4 to 14 C atoms, preferably comprising 4 to 9 C atoms. Specific examples, without wishing to be restricted by this enumeration, are methyl acrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, and their branched isomers, such as isobutyl acrylate, 2-ethylhexyl acrylate, 2-ethylhexyl methacrylate, isooctyl acrylate, and isooctyl methacrylate.

Further classes of compound for use are monofunctional acrylates and/or methacrylates of bridged cycloalkyl alcohols, consisting of at least 6 C atoms. The cycloalkyl alcohols may also be substituted, as for example by C-1-6-alkyl groups, halogen atoms or cyano groups. Specific examples are cyclohexyl methacrylates, isobornyl acrylate, isobornyl methacrylates, and 3,5-dimethyladamantyl acrylate.

In addition to the above-stated acrylates and methacrylates it is also possible as further comonomers to use moderate basic monomers are, for example, N,N-dialkyl-substituted amides, such as N,N-dimethylacrylamide, N,N-dimethylmethylmethacrylamide, N-tert-butylacrylamide, N-vinylpyrrolidone, N-vinyllactam, dimethylaminomethyl methacrylate, dimethylaminoethyl acrylate, diethylaminoethyl methacrylate, diethylaminoethyl acrylate, N-methylolmethacrylamide, N-(buthoxymethyl)methacrylamide, N-methylolacrylamide, N-(ethoxymethyl)acrylamide, N-isopropylacrylamide, this enumeration being non-conclusive.

Further examples of comonomers are maleic anhydride, itaconic anhydride, glyceridyl methacrylate, phenoxyethyl acrylate, phenoxyethyl methacrylate, 2-butoxyethyl methacrylate, 2-butoxyethyl acrylate, cyanoethyl methacrylate, cyanoethyl acrylate, glyceryl methacrylate, and tetrahydrofurfuryl acrylate, this enumeration being non-conclusive.

In a further very preferred procedure, comonomers used are vinyl esters, vinyl ethers, vinyl halides, vinylidene halides, and vinyl compounds with aromatic rings and heterocycles in α position. Here as well, mention may be made, nonexclusively, of certain examples: vinyl acetate, vinyl formamide, vinyl pyridine, ethyl vinyl ether, vinyl chloride, vinylidene chloride, and acrylonitrile.

Moreover, in a further very preferred procedure, photoinitiators having a copolymerizable double bond are used. Suitable photoinitiators are Norrish-I and II photoinitiators. Examples are, for example, benzoin acrylate and an acrylated benzophenone from UCB (Ebecryl P 36®). In principle it is possible to copolymerize all photoinitiators which are known to the skilled worker and which are able to crosslink the polymer via a free-radical mechanism under UV irradiation. An overview of possible useful photoinitiators which can be functionalized with a double bond is given in Fouassier: “Photoinitiation, Photopolymerization and Photocuring: Fundamentals and Applications”, Hanser-Verlag, Munich 1995. Additionally use is made of Carroy et al. in “Chemistry and Technology of UV and EB Formulation for Coatings, Inks and Paints”, Oldring (ed.), 1994, SITA, London.

In a further preferred procedure, the comonomers described are admixed with monomers which possess a high static glass transition temperature. Suitable components include aromatic vinyl compounds, such as styrene, for example, in which case preferably the aromatic rings consist of C₄ to C₁₈ units and may also contain heteroatoms. Particularly preferred examples are 4-vinylpyridine, N-vinylphthalimide, methylstyrene, 3,4-dimethoxystyrene, benzyl acrylate, benzyl methacrylate, phenyl acrylate, phenyl methacrylate, t-butylphenyl acrylate, t-butylphenyl methacrylate, 4-biphenylyl acrylate and methacrylate, 2-naphthyl acrylate and methacrylate, and also mixtures of these monomers, this enumeration not being conclusive.

For further development it is possible to admix the polymers with resins. Tackifying resins for addition that can be used include, without exception, all existing tackifier resins described in the literature. As representatives, mention may be made of the pinene resins, indene resins, and rosins, their disproportionated, hydrogenated, polymerized, and esterified derivatives and salts, the aliphatic and aromatic hydrocarbon resins, terpene resins and terpene-phenolic resins, and also C5, C9, and other hydrocarbon resins. Any desired combinations of these and further resins may be used in order to adjust the properties of the resulting adhesive in accordance with requirements. Generally speaking, it is possible to use all resins that are compatible (soluble) with the corresponding polyacrylate; in particular, reference may be made to all aliphatic, aromatic, alkylaromatic hydrocarbon resins, hydrocarbon resins based on pure monomers, hydrogenated hydrocarbon resins, functional hydrocarbon resins, and natural resins. Express reference may be made to the depiction of the state of the art in the “Handbook of Pressure Sensitive Adhesive Technology” by Donatas Satas (van Nostrand, 1989).

Additionally and optionally it is possible for plasticizers (plasticizing agents), nucleators, expandants, compounding agents and/or aging inhibitors, in the form for example of primary and secondary antioxidants or in the form of light stabilizers, to be added.

Additionally it is possible to admix crosslinkers and crosslinking promoters. Suitable crosslinkers for electron beam crosslinking and UV crosslinking are, for example, difunctional or polyfunctional acrylates, difunctional or polyfunctional isocyanates (including those in blocked form) or difunctional or polyfunctional epoxides.

For optional crosslinking—although not preferred crosslinking—with UV light it is possible to add UV-absorbing photoinitiators. Useful photoinitiators which are very good to use are benzoin ethers, such as benzoin methyl ether and benzoin isopropyl ether, substituted acetophenones, such as 2,2-diethoxyacetophenone (available as Irgacure 651® from Ciba Geigy®), 2,2-dimethoxy-2-phenyl-1-phenylethanone, dimethoxyhydroxyaceto-phenone, substituted α-ketols, such as 2-methoxy-2-hydroxypropiophenone, aromatic sulfonyl chlorides, such as 2-naphthylsulfonyl chloride, and photoactive oximes, such as 1-phenyl-1,2-propanedione2-(O-ethoxycarbonyl)oxime, for example.

The abovementioned photoinitiators and others which can be used, and others of the Norrish I or Norrish II type, may contain the following radicals: benzophenone, acetophenone, benzil, benzoin, hydroxyalkylphenone, phenyl cyclohexyl ketone, anthraquinone, trimethylbenzoyl phosphine oxide, methylthiophenyl morpholinyl ketone, amino ketone, azo benzoin, thioxanthone, hexarylbisimidazole, triazine, or fluorenone, it being possible for each of these radicals to be additionally substituted by one or more halogen atoms and/or one or more alkyloxy groups and/or one or more amino groups or hydroxyl groups. A representative overview is given by Fouassier: “Photoinitiation, Photopolymerization and Photocuring: Fundamentals and Applications”, Hanser-Verlag, Munich 1995. Additionally it is possible to employ Carroy et al. in “Chemistry and Technology of UV and EB Formulation for Coatings, Inks and Paints”, Oldring (ed.), 1994, SITA, London.

As hotmelt PSAs it is additionally possible to use rubber-based PSAs. There are wide possibilities for variation, whether from the group of the natural rubbers or synthetic rubbers or whether from any desired blend of natural rubbers and/or synthetic rubbers, the natural rubber or natural rubbers being selectable in principle from all available grades such as, for example, crepe, RSS, ADS, TSR or CV types, depending on level of viscosity and purity required, and the synthetic rubber or synthetic rubbers from the group of the randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate copolymers (EVA) and polyurethanes and/or blends thereof.

Additionally and preferably it is possible to admix rubbers, for the purpose of improving their processing properties, with thermoplastic elastomers in a weight fraction of 10%-50% by weight, based in fact on the overall elastomer fraction. Representatives that may be mentioned at this point are in particular the especially compatible styrene-isoprene-styrene (SIS) and styrene-butadiene-styrene (SBS) types.

As plasticizers likewise for addition it is possible to use all of the plasticizing substances known from adhesive-tape technology. These include, among others, the paraffinic and naphthenic oils, (functionalized) oligomers such as oligobutadienes, oligoisoprenes, liquid nitrile rubbers, liquid terpene resins, vegetable and animal oils and fats, phthalates, and functionalized acrylates.

### Carrier Film

The carrier film e can be produced using in principle all film-forming, extrudable polymers. One preferred version uses polyolefins. Preferred polyolefins are prepared from ethylene, propylene, butylene, and hexylene, where in each case the pure monomers can be polymerized, or mixtures of the stated monomers are copolymerized. Through the polymerization process and through the selection of the monomers it is possible to control the physical and mechanical properties of the polymer film, such as the softening temperature and the tensile strength, for example.

Another preferred version uses polyvinyl acetates. Polyvinyl acetates may contain not only vinyl acetate but also vinyl alcohol as a comonomer, and the free alcohol fraction can be varied within wide limits.

Another preferred version uses polyesters as carrier film. One particularly preferred version uses polyesters based on polyethylene terephthalate (PET).

Another preferred version uses polyvinyl chlorides (PVC) as a film. To increase the temperature stability it is possible for these films to include stiffening comonomer as well, or to be radiation-crosslinked in the course of the inventive operation. Furthermore, the PVC may also include components which soften the film (plasticizers).

Another preferred version uses polyamides for producing films. The polyamides may be composed of a dicarboxylic acid and a diamine or of two or more dicarboxylic acids and diamines. Besides dicarboxylic acids and diamines it is also possible to use amines and carboxylic acids of higher functionality, also in combination with the dicarboxylic acids and diamines. The film is stiffened using preferably cyclic, aromatic or heteroaromatic starting monomers.

Another preferred version uses polymethacrylates to produce films. Here the glass transition temperature of the film can be controlled through the choice of the monomers (methacrylates and in part also acrylates). Furthermore, the polymethacrylates may also include additives in order, for example, to increase the flexibility of the film or to raise or lower the glass transition temperature, or to minimize the formation of crystalline segments.

Another preferred version uses polycarbonates for producing films.

Furthermore, in a further version of the invention, it is possible to use polymers and copolymers based on vinylaromatics and vinylheteroaromatics for producing the carrier film. For this purpose, for example, the pool of the following compounds is available, the enumeration making no claim to completeness: styrene, for example, in which case preferably the aromatic rings consist of C₄ to C₁₈ units and may also contain heteroatoms. Particularly preferred examples are 4-vinylpyridine, N-vinylphthalimide, methylstyrene, 3,4-dimethoxystyrene, benzyl acrylate, benzyl methacrylate, phenyl acrylate, phenyl methacrylate, t-butylphenyl acrylate, t-butylphenyl methacrylate, 4-biphenylyl acrylate and methacrylate, 2-naphthyl acrylate and methacrylate, and also mixtures of these monomers.

To produce a material in film form it may be appropriate here as well to add additives and further components which enhance the film-promoting properties, reduce the tendency for crystalline segments to be formed, and deliberately improve or else, where appropriate, impair the mechanical properties.

A further version of the invention uses films based on polyoxymethylene or polyoxyethylene or combinations of these or similar polyoxyalkylenes.

### Release Film

The release film can be produced using in principle all film-forming, extrudable polymers. In one preferred version of the invention the release film is composed of a carrier film b provided on both sides with a release varnish a, a′, preferably silicone-based. In one very preferred version of the invention the release varnishes are graduated—that is, the release values differ on the top and bottom sides. In this way the unwindability of the double-sided adhesive tape is ensured.

One preferred version uses polyolefins as carrier material for the release film. Preferred polyolefins are prepared from ethylene, propylene, butylene, and hexylene, where in each case the pure monomers can be polymerized, or mixtures of the stated monomers are copolymerized. Through the polymerization process and through the selection of the monomers it is possible to control the physical and mechanical properties of the polymer film, such as the softening temperature and the tensile strength, for example.

Another preferred version uses polyvinyl acetates as carrier material for the release film. Polyvinyl acetates may contain not only vinyl acetate but also vinyl alcohol as a comonomer, and the free alcohol fraction can be varied within wide limits.

Another preferred version uses polyesters as carrier material for the release film. One particularly preferred version uses polyesters based on polyethylene terephthalate (PET).

Another preferred version uses polyvinyl chlorides (PVC) as a carrier material for the release film. To increase the temperature stability it is possible for these films to include stiffening comonomer as well, or to be radiation-crosslinked in the course of the inventive operation. Furthermore, the PVC may also include components which soften the film (plasticizers).

Another preferred version uses polyamides as a carrier material for the release film. The polyamides may be composed of a dicarboxylic acid and a diamine or of two or more dicarboxylic acids and diamines. Besides dicarboxylic acids and diamines it is also possible to use amines and carboxylic acids of higher functionality, also in combination with the dicarboxylic acids and diamines. The film is stiffened using preferably cyclic, aromatic or heteroaromatic starting monomers.

Another preferred version uses polymethacrylates as a carrier material for the release film. Here the glass transition temperature of the film can be controlled through the choice of the monomers (methacrylates and in part also acrylates). Furthermore, the polymethacrylates may also include additives in order, for example, to increase the flexibility of the film or to raise or lower the glass transition temperature, or to minimize the formation of crystalline segments.

Another preferred version uses polycarbonates as a carrier material for the release film.

Furthermore, in a further version of the invention, it is possible to use polymers and copolymers based on vinylaromatics and vinylheteroaromatics for producing the release films. For this purpose, for example, the pool of the following compounds is available, the enumeration making no claim to completeness: styrene, for example, in which case preferably the aromatic rings consist of C₄ to C₁₈ units and may also contain heteroatoms. Particularly preferred examples are 4-vinylpyridine, N-vinylphthalimide, methylstyrene, 3,4-dimethoxystyrene, benzyl acrylate, benzyl methacrylate, phenyl acrylate, phenyl methacrylate, t-butylphenyl acrylate, t-butylphenyl methacrylate, 4-biphenylyl acrylate and methacrylate, 2-naphthyl acrylate and ethacrylate, and also mixtures of these monomers.

To produce a material in film form it may be appropriate here as well to add additives and further components which enhance the film-promoting properties, reduce the tendency for crystalline segments to be formed, and deliberately improve or else, where appropriate, impair the mechanical properties.

A further version of the invention uses, as carrier material for the release film, polyoxy-methylene or polyoxyethylene or combinations of these or similar polyoxyalkylenes.

In a further preferred version of the invention it is also possible to use two-layer release films. In this case the films themselves possess antistick properties. In this case it is particularly preferred to use fluorine-containing polymers, the antistick properties being boosted by an increase in the fluorine fraction in the polymer.

In order to achieve different antistick properties on two sides, it may also be necessary to emboss the release film on one side. This may be done through the shape of the extrusion die or by rolling the surface following extrusion, in which case the roll preferably includes a structure which is to be transferred to the release film.

### Release Layer

The release layers a, a′ are based in one preferred version on silicone or fluorinated polymers.

Silicones, called polyorganosiloxanes in chemistry, are similar in their structure to organically modified quartz. They consist of a framework constructed in alternation from silicon and from oxygen. This framework may be variously modified by organic, carbon-containing groups. Virtually all silicone products can be derived from the following three groups of base materials:
silicone fluids
silicone rubbers
silicone resins

For coating from the melt it is of advantage if the materials have a crosslinking potential, thus, for example, by crosslinking with UV light. These compounds are coated as 100% systems and have, for example, epoxy groups, which then, following UV activation with a photocation generator, undergo crosslinking and thus form a resistant release layer. As UV photocation generators it is possible, for example, to use the iodonium salt UV 9385 C from GE Bayer Silicones. As a further photoinitiator it is also possible to use UV 9380 C and UV 9390 C from GE Bayer Silicones. As silicones containing crosslinking epoxy groups it is possible to use UV 9600, UV 9300, UV 9315, UV 9400 or UV 9500 from GE Bayer Silicones. Furthermore, in order to control the release effect, it is possible to add additives, such as release force regulators, for example. Such additives are, for example, UV 9440E or UV9430 from GE Bayer Silicones.

Furthermore, it is possible to employ silicone rubbers of the ELASTOSIL® series from Wacker as application-ready one-component compositions of fluid to firm consistency. These rubbers react with the moisture in the air to form an elastic silicone rubber.

Under atmospheric humidity, crosslinking begins, with elimination of cleavage products. Depending on the crosslinker employed, a distinction is made between the following systems:
basic or amine systems: small amounts of an amine are given off
acid or acetoxy systems: small amounts of acetic acid are given off.

Neutral or oxime and/or alkoxy systems: small amounts of an oxime or alcohol are given off.

In addition it is also possible to use silicone waxes as parting layers.

### Primer Layer

Compounds used as primers d are generally compounds which by means of reactive groups produce chemical bonds between carrier film and hotmelt PSA, or which are activated by heat and so form a strong adhesion to the carrier film and to the hotmelt PSA. The heat-activatable primers include, for example, PVC/PVAc copolymers, which are also used, for example, as sealing layers for polyester films. Reactive primers used are, for example, compounds containing isocyanate or aziridine groups, which are then able to enter into chemical reactions when combined with the carrier film and the hotmelt PSA. The same is true of what are referred to as Saran primers.

Furthermore, however, it is also possible with outstanding effect to use polymers which carry grafted-on functional groups, such as maleic anhydride, hydroxyl or epoxy, for example. In order to allow a reaction with the carrier and/or with the PSA it may be of advantage to add accelerating substances which either accelerate the reaction directly or are only generated in situ as a result of UV light, for example. Suitability here may be possessed, for example, by Lewis acids or Lewis bases.

Suitable Lewis bases for accelerating, for example, epoxides are, very effectively, aminic bonds.

As Lewis acids it is possible for example to use boron trifluorides or zinc salts. Suitable UV photocation generators are, for example, iodonium salts. UV base generators as well, however, are also known.

### Structure of the Double-Sided Pressure-Sensitive Adhesive Tape

In one preferred embodiment the thickness of the carrier film e is between 5 and 500 μm, very preferably between 10 and 100 μm.

In one preferred embodiment the thickness of the hotmelt PSA c and c′ is between 5 and 500 μm, very preferably between 10 and 100 μm. The thicknesses of the hotmelt PSA c and c′ in one preferred version of the invention are identical, but may also differ in thickness if, in particular, different bond strengths are required on either side (open and closed side). To solve this problem it is additionally possible to employ two different hotmelt PSAs c and c′ on either side.

In one preferred version the thickness of the release film (sum of release layer a, release layer a′, and carrier film b for release film) is between 5 and 100 μm, very preferably between 10 and 50 μm. The coatweight of release layers a and a′ is preferably between 1.0 and 4 g/m², very preferably between 2 and 3 g/m² on each side.

The thickness of the primer layer or layers (d) on the respective carrier film side e is preferably between 0.5 and 5 μm, very preferably between 1 and 4 μm.

### Coating Process

The double-sided pressure-sensitive adhesive tape is produced by coating the components described above, preferably from the melt.

For the production process it may therefore be necessary to remove the solvent from the individual components. Here it is possible in principle to use all of the processes known to the skilled worker. One common process is that of concentration by distillation in a reactor, in a batch or cascade process. One very preferred process is that of concentration using a single-screw or twin-screw extruder. The twin-screw extruder may be operated co- or counter-rotatingly. The solvent or water is preferably distilled off over two or more vacuum stages. Moreover, counterheating is carried out, depending on the distillation temperature of the solvent. The residual solvent fractions are preferably <1%, more preferably <0.5%, and very preferably <0.2%. Following concentration, the hotmelt or hotmelts is or are processed further from the melt.

Additionally it may be necessary to have to admix additives, fillers, lubricants, antiblocking agents, etc to the individual components. For homogeneous incorporation into the melt it is preferred to use a twin-screw extruder or a planetary roller extruder.

In the inventive process the components are coated with particular preference in a coextrusion process. This may operate in accordance with the adapter process, with the components being laid layerwise over one another in a coextrusion adapter (feed block). This assembly is then shaped to form the film in a downstream extrusion die, and preferably placed onto a chill roll or a liner. Where no suitable operating parameters can be found to match the viscosities to one another, the process variant of the multi-manifold die (MMD) may be employed. With this variant it is possible to manage relatively large differences in viscosity, especially when the separate flow channels are isolated thermally from one another and/or the entire flow section is kept very short by means of a suitable die lip geometry. In order to keep the operating complexity resulting from the high number of manifolds manageable for the operator, it is also possible to employ a combination of adapter coextrusion and multi-manifold die coextrusion. In this case the only components shaped separately in the MMD are those whose viscosities cannot be approximated even by means of suitable operating parameters (for example, temperature regime, joint residence time, etc). In this case the design of the manifolds is selected according to the flow conditions and viscosity conditions of the extruded components. Suitable adapter systems and die systems can be purchased, for example, from the Cloeren Company (Orange, Tex.), Kuhne GmbH (St. Augustin, Germany) or Extrusion Dies, Incorporated (Chippewa Falls, Wis.). A suitable construction is described inter alia in German patent No. 197 16 996 C1.

With one of the above-described coextrusion constructions, tailored to the raw materials, in one particularly preferred case all of the desired layers, comprising release film, carrier film, PSA, and, if desired, primers, a, a′, b, c, c′, d, and e, are produced in one step. Depending on the requirements concerning the complexity of the operation and concerning the adhesive tape and the materials employed it is also possible to omit some of the layers if desired. For example, through a suitable choice of the PSAs c and c′ and of the carrier film e, it is also possible to omit one or two primer layers d. It may be the case, furthermore, that, given a suitable choice of PSA c and c′, only individual components of the release film are required, such as carrier film b or carrier film b and release layer a′ for example (b and a, a′ and also c for transfer tapes). To reduce the operational complexity it is also possible to do without the inline coextrusion of a release liner a, a′, b.

For the inventive coating the individual components are conveyed in the form of polymers or in the form of reactive systems separately to the described preferred coextrusion arrangement. This takes place in the form of a melt by means of standard commercial melters, drum melting, extruders, etc. The pressure needed can be produced pneumatically, in the extruder, by means of suitable melt pumps or other standard commercial melting and conveying elements. In the coextrusion apparatus the melt flows are combined, simultaneously or successively, shaped in a die lip to form the film, and subsequently placed on a chill roll or a substrate. Also possible is transfer coating via an antiadhesive surface, by means of an antiadhesive conveyor belt, or else by means of transfer by water film.

For the inventive process it may be of advantage if, after the extrusion operation, pressure is exerted on the layer assembly in order, for example, to improve the anchoring of individual layers to one another. This can be done by means of suitable, antiadhesively finished rolls.

For the process it may also be of advantage, furthermore, if individual extrusion steps are separated from one another. For example, the carrier film e may be coextruded with the two optional primer layers d in one step, coated with PSA c, laminated with a coextruded release film (a, a′ and b), and, finally, produced in the form of the double-sided pressure-sensitive adhesive tape by extrusion of the PSA c′ onto the assembly. These worksteps may all take place inline, although the lamination or coating of separately produced release films or carrier films is also possible. For laminating together, use is made of conventional laminating rolls, which possess for example a rubber coating with a defined hardness or, if there is direct contact with the PSA, exhibit a three-dimensionally cured silicone layer or a ceramic matrix with a coating comprising special, anti-adhesive surface structures.

It may be necessary, furthermore, for optional UV crosslinking of the PSAs c and c′, or of the release layers a and a′, to carry out shortwave ultraviolet irradiation in a wavelength range from 200 to 400 nm, depending on the UV photoinitiator used; in particular this is done using high-pressure or medium-pressure mercury lamps, with an output of 80 to 240 W/cm. The irradiation intensity is matched to the particular quantum yield of the UV photoinitiator, the degree of crosslinking that is to be set, and the extent of orientation.

In a further preferred crosslinking process, the PSAs c and c′ and/or the release layers a and a′ are crosslinked using electron beams. Typical irradiation equipment that may be employed includes linear cathode systems, scanner systems, or segmented cathode systems when the apparatus in question involves electron beam accelerators. A comprehensive description of the state of the art, and the most important process parameters, are found in Skelhorne, Electron Beam Processing, in Chemistry and Technology of UV and EB formulation for Coatings, Inks and Paints, Vol. 1, 1991, SITA, London. The typical acceleration voltages are situated in the range between 50 and 500 kV, preferably 80 and 300 kV. The irradiation doses employed range between 5 to 150 kGy, in particular between 20 and 100 kGy. It is also possible to employ both crosslinking processes or other processes which permit high-energy irradiation.

If possible, the entire double-sided adhesive tape can be crosslinked right through in one operation. If necessary, the crosslinking operation or operations can also be carried out at suitable points in the overall process, at which separate crosslinking steps of one or more components are particularly advantageous. This may be the case, for example, when certain thicknesses of material are exceeded or when individual components are particularly sensitive to radiation.

### EXAMPLES

The invention is described below through examples, without wishing to undertake any unnecessary restriction as a result of the choice of the samples investigated.

The following test methods were employed for examining the double-sided pressure-sensitive adhesive tape.

### 180° Bond Strength Test (Test A)

A 20 mm wide strip of an acrylate PSA coated onto polyester or siliconized release paper was applied to steel plates (Test A1) or to PE plates (Test A2). The pressure-sensitive adhesive strip was pressed onto the substrate twice using a 2 kg weight. The adhesive tape was then immediately peeled from the substrate at 30 mm/min and at an angle of 180°. The steel plates were washed twice with acetone and once with isopropanol. New PE plates were used in each case. The measurement results are reported in N/cm and are averaged from three measurements. All measurements were carried out at room temperature under stabilized conditions.

### Shear Strength (Test B)

A 13 mm wide strip of the adhesive tape was applied to a smooth steel surface which was cleaned three times with acetone and once with isopropanol. The area of application was 20 mm*13 mm (length*width). Subsequently, with an applied pressure of 2 kg, the adhesive tape was pressed onto the steel support four times. It was loaded at room temperature with a 1 kg weight. The shear resistance times measured are reported as the holding power in minutes, and correspond to the average from three measurements.

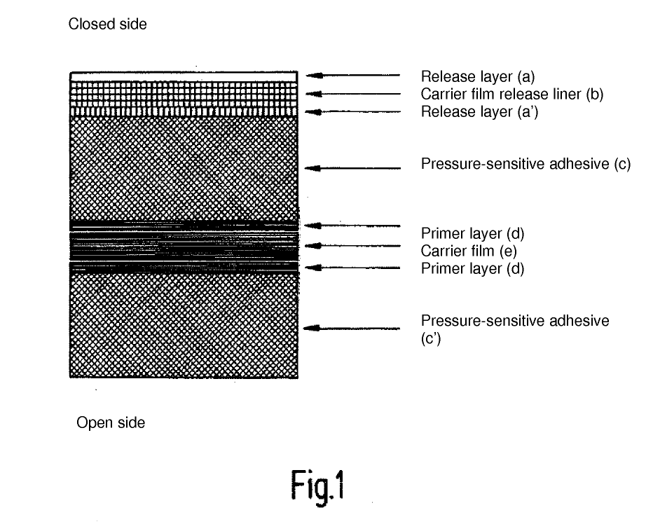

A preferred double-sided pressure-sensitive adhesive tape is shown in FIG. 1. It comprises, from the closed side to the open side, the following layers: release layer a, carrier film b, release layer a′, pressure-sensitive adhesive layer c, primer layer d, carrier film e, and the layer c′ of pressure-sensitive adhesive.

Preparation of PSAs c and c′

### Polymer 1

A 200 L reactor conventional for free-radical polymerizations was charged with 20 kg of methyl acrylate, 60 kg of 2-ethylhexyl acrylate, 10 kg of acrylic acid and 53.3 kg of acetone/isopropanol (97:3). After nitrogen gas had been passed through the reactor for 45 minutes with stirring, the reactor was heated to 58° C. and 40 g of 2,2′-azo-isobutyronitrile (AIBN) were added. Then the external heating bath was heated to 75° C. and the reaction was carried out constantly at this external temperature. After a reaction time of 1 hour a further 40 g of AIBN were added. After 5 and 10 hours, dilution took place with 15 kg of acetone/isopropanol (97:3) each time. After 6 hours and 8 hours, 100 g portions of dicyclohexyl peroxydicarbonate (Perkadox 16®, Akzo Nobel), in solution each in 800 g of acetone, were added. After a reaction time of 24 hours the reaction was terminated and the system cooled to room temperature. Subsequently the polymer was freed from the solvent under reduced pressure and under hot conditions at 120° C.

The following further materials were used for the production:

Carrier film: Moplen RP 220N (random copolymer, polypropylene-based, melting temperature of 147° C., from Basell Polyolefins)
Primer: Fusabond P MD511 D (chemically modified polypropylene, melting point of 162° C.).

The release liner used is a standard commercial glassine paper siliconized on both sides, with graduated release forces, and with a grammage of 92 g/m².

### Example 1

Liner is not coextruded owing to complexity.
Pressure-sensitive adhesive layers c and c′: each 20 g/m²
Primer layers d: 3 g/m²
Carrier layer e: 12 μm

### Process for Producing a Double-Sided Pressure-Sensitive Adhesive Tape

The different layers were plasticized and conveyed in separate single-screw extruders. The conveying performance is set via the rotary speed and geometry of the screw, and in this way the thicknesses of the individual layers are also controlled. The single-screw extruders are connected via heated lines to the coextrusion apparatus. Prior to introduction into the coextrusion die, the materials are again filtered in order to avoid disruptions owing to gel and extraneous substances.

The carrier is first coextruded with the primer in the feed block. For this purpose the feed block, from Kuhne GmbH, St Augustin (cf. patent DE 38 03 412 C1), is set to a temperature of 195° C. The melt temperature of the carrier component is 210° C., while the primer layers are extruded at 185° C. The primer melt stream is generated in only one extruder, and divided into the two separate melt streams by means of a T-shaped manifold. In this case it is necessary to ensure a symmetrical design of the separate flow sections for the primer streams. Any differences in throughput that do occur can be adapted by means of the particular construction of the Kuhne multi-layer adapter. Uniform combination flow rates of the melt streams in the adapter, and the layer distribution, can be set in this case by means of a stepless adjustment using a rotatable bolt. For this purpose the bolts are equipped with holdup channels and manifolds which allow precision adaptation of the distribution to the Theological circumstances. Herewith it is also possible to coextrude melts having significantly different viscosity behaviors and/or different temperature regimes, by means of the feed block.

The carrier/primer assembly then flows into the multi-manifold die, which is heated to a temperature of 180° C. In this context, particularly short flow paths and a sufficient throughput must be ensured in order to minimize the heat loss from the hot carrier layer through the primer into the cooler die walls. In the MMD, the flows of adhesive, extruded at 170° C., are shaped to the coating width in separate coat-hanger dividers. They are then placed on either side onto the carrier/primer assembly already shaped in the MMD, which assembly runs in centrally, with subsequent calibration by the flexible die lips. In this context a particularly short lip length must be ensured, in order to allow the viscosity conditions to be controlled by means of heat compensation flows of the different melt layers. The resulting 5-layer assembly is drawn and placed onto the fluid film. Benign electron beam crosslinking by means of fluid film with subsequent inline transfer is conventional.

The emergent width of the coextruded assembly is 330 mm; the die gap is set at 200 μm. The layer thickness of the assembly is set by appropriate harmonization of the melt flows with the take-off speed of the chill roll. The web speed was 40 m/min, the EBC crosslinking of the PSA takes place in line at 30 kGy with an acceleration voltage of 180 kV. The line used was from Electron Crosslinking AB, Halmstad, Sweden. In this system, in the radiation zone, the atmospheric oxygen was displaced by flushing with pure nitrogen. The crosslinked assembly is transferred to the release liner from the fluid film by means of a placement roll, and wound up to form a roll.

### Example 2

The liner is not coextruded owing to complexity
Pressure-sensitive adhesive layers c and c′: each 60 g/m²
Primer layers d: 5 g/m²
Carrier layer e: 25 μm

As described above, the altered layer thicknesses were controlled via the extruder throughput altered in example 2. In deviation from Example 1, moreover, the die gap was set at 300 μm and the belt speed was reduced to 18 m/min. The other settings were retained in the same way as in Example 1, the layer distribution in the multi-layer adapter being readjusted by an alteration to the bolt position.

### Results

To evaluate the properties, Examples 1 and 2 were investigated after storage for 14 days at 23° C. and 50% humidity. The rolls of adhesive tape from both examples were unwound with no problems. Thereafter the adhesive properties were determined in accordance with test methods A and B:

TABLE 1
Overview of adhesive properties ascertained

| Ex- | Bond strength on steel | Bond strength on PE | Holding powers |
|---|---|---|---|
| ample | (Test A1) | (Test A2) | (Test B) |
| 1 | 5.2 N/cm | 0.9 N/cm | 2770 min. |
| 2 | 6.3 N/cm | 1.5 N/cm | 1455 min. |

The adhesive properties demonstrate that with the inventive process conventional double-sided adhesive tapes can be made available for industrial applications.

### LIST OF REFERENCE SYMBOLS

a release layer
a′ release layer
b carrier film (release liner)
c pressure-sensitive adhesive layer
c′ layer of pressure-sensitive adhesive
d primer layer
e carrier film

1. A process for producing a double-sided pressure-sensitive adhesive tape with a closed and an open side, comprising a carrier film provided on both sides with a pressure-sensitive adhesive layer, the carrier film being a carrier film not based on rubber, and at least one release film being located on the closed side, on one pressure-sensitive adhesive layer (c), said process comprising forming
two identical or different pressure-sensitive adhesives,
a carrier film-forming polymer, and
a release film-forming polymer,
from the melt and combining to form an assembly, and crosslinking the pressure-sensitive adhesives by physical treatment and/or chemical radiation treatment.

2. The process of claim 1, wherein at least one primer layer is formed between the carrier film and the pressure-sensitive adhesive layers.

3. The process of claim 1, wherein, to form the at least one release film, a carrier film (release liner) is formed which if desired comprises a release layer on one or both sides.

4. The process of claim 1, wherein the producing takes place in a batch process or cascade process.

5. The process of claim 4, wherein the producing and coating take place by means of a coextrusion process.

6. The process of claim 5, wherein the coextrusion process takes place by an adapter process, with the components being laid layerwise one above another and shaped by means of an extrusion die and/or a multi-manifold die.

7. The process of claim 6, wherein the individual components in the form of polymers or in the form of reactive systems as a melt are conveyed separately to a coextrusion system, where simultaneously or successively they are combined, shaped in a die lip to form the film, and subsequently placed.

8. The process of claim 6, wherein individual extrusion steps take place separately from one another.

9. The process of claim 6, wherein the carrier film, if desired with one or two primer layers above and below, is (co)extruded in one step; the carrier film or one primer layer is coated with a first pressure-sensitive adhesive, which is then laminated with a release film; and lastly a second pressure-sensitive adhesive layer on the open side is extruded onto the assembly.

10. The process of claim 1, wherein the producing takes place under pressure on the layer assembly.

11. The process of claim 1, wherein the thickness of the carrier film is between 5 and 500 μm.

12. The process of claim 1, wherein the thickness of each pressure-sensitive adhesive layer is between 5 and 500 μm, the thickness of the two pressure-sensitive adhesive layers being identical or different.

13. The process of claim 1, wherein the thickness of the release film is between 5 and 100 μm.

14. The process of claim 13, wherein the coatweight of the release layers is between 1.0 and 4 g/m².

15. The process of claim 1, wherein the thickness of the primer layer is between 0.5 and 5 μm.

16. The process of claim 1, wherein all film-forming and extrudable polymers function as carrier film.

17. The process of claim 16, wherein the carrier film is a polyester.

18. The process of claim 1, wherein the pressure-sensitive adhesive layers are formed of polymers and/or copolymers which represent pressure-sensitive adhesives that can be processed from the melt.

19. The process of claim 1, wherein the pressure-sensitive adhesive layers are composed of like or different materials.

20. The process of claim 18, wherein the pressure-sensitive adhesive layers are formed of pressure-sensitive adhesives based on styrene block copolymers, based on at least one block copolymer of the general type P(A)-P(B)-P(A) (triblock polymers) and P(B)-P(A)-P(B) (inverse triblock polymers), based on at least one block copolymer at least containing the unit P(B)-P(A)-P(B) composed of at least two polymer blocks P(B) and at least one polymer block P(A), or of polyacrylate hotmelt adhesives composed of polymers based on at least 50% by weight of an acrylic ester and/or methacrylic ester with the formula CH₂═CH(R₁)(COOR₂), where R₁ is H or CH₃ and R₂ is a linear, branched or cyclic alkyl chain having 1-20 C atoms.

21. The process of claim 1, wherein all film-forming and extrudable polymers function as carrier film of the release film.

22. The process of claim 21, wherein the carrier film of the release film is a polyester.

23. The process of claim 21, wherein the release film is composed of a carrier film which is provided with a release layer in the form of a release varnish.

24. The process of claim 1, wherein the release layers represent a layer based on silicone or fluorinated polymers.

25. The process of claim 23, wherein the release varnish is mutually graduated in its release values.

26. The process of claim 1, wherein two-layer release films are used, and if desired have embossings for the purpose of increasing the antistick properties.

27. The process of claim 1, wherein the primer layer is formed of PVC/PVAc copolymers, of compounds containing isocyanate or aziridine groups, and of polymers which carry grafted-on functional groups.

28. A double-sided pressure-sensitive adhesive tape with a closed and an open side, comprising a carrier film provided on both sides with a pressure-sensitive adhesive layer, the carrier film being a carrier film not based on rubber, and at least one release film being located on the closed side, on one pressure-sensitive adhesive layer.

29. The pressure-sensitive adhesive tape of claim 28, wherein between the carrier film and the pressure-sensitive adhesive layers at least one primer layer is located.

30. The pressure-sensitive adhesive tape of claim 28, wherein the at least one release film has a carrier film (release liner) which if desired comprises a release layer on one or both sides.

31. A combination comprising a component of an electronics device adhered to a pressure-sensitive adhesive tape of claim 28.
